(19) United States
(12) Patent Application Publication
(10) Pub. No.: US 2026/0141683 A1
(43) Pub. Date: May 21, 2026

(54) LABEL CORRECTION DEVICE FOR TRAINING DATA IN MACHINE LEARNING, LABEL CORRECTION METHOD, AND STORAGE MEDIUM

(71) Applicant: NEC Corporation, Tokyo (JP)

(72) Inventor: Shigeaki NAMIKI, Tokyo (JP)

(73) Assignee: NEC Corporation, Tokyo (JP)

(21) Appl. No.: 19/366,850

(22) Filed: Oct. 23, 2025

(30) Foreign Application Priority Data
Nov. 15, 2024 (JP) 2024-199548

(51) Int. Cl. G06V 10/764; G06V 10/40; G06V 10/74; G06V 10/762; G06V 10/774

(52) U.S. Cl. CPC G06V 10/764; G06V 10/40; G06V 10/761; G06V 10/762; G06V 10/774; G06V 2201/03

(57) ABSTRACT

The label correction device 1X includes a clustering means 32X, a subclass identification means 33X, and a label correction means 34X. The clustering means 32X classifies pairs of an image and a class label of the image, into subclasses by clustering a feature of the image. The subclass identification means 33X identifies a noise-mixed subclass which includes a pair having an error in the class label, based on an index of a variation in the feature of each of the subclasses. The label correction means 34X selects a subclass among the subclasses most similar to the pair belonging to the noise-mixed subclass from among all the subclasses, and replace the class label of the pair in the noise-mixed subclass with the class label indicating a class of the selected subclass. It can assist decision making on correction of incorrect labels in training data.

### INCORPORATION BY REFERENCE

This application is based upon and claims the benefit of priority from Japanese Patent Application No. 2024-199548, filed on Nov. 15, 2024, the disclosure of which is incorporated herein in its entirety by reference.

### TECHNICAL FIELD

The present disclosure relates to a technical field of a label correction device, a label correction method, and a storage medium related to training data of a machine learning model.

### BACKGROUND

Conventionally, there is known a technique for performing machine learning of a classification model using, as training data, a set of pairs of an image and a label indicating a class to which the image belongs. For example, Patent Literature 1 discloses a technique of classifying an object image into a predetermined number of clusters by using an evaluation data set in which an object image and class information of the object image are associated with each other, and identifying a cluster having an erroneous label from the classified clusters.

### CITATION LIST

### Patent Literature

Patent Literature 1: JP2022-150552A

### SUMMARY

In a case where imbalanced data with a bias in the number of samples for each class is obtained as training data, overfitting easily occurs because samples belonging to minority classes are frequently used. In order to prevent such overfitting, for example, a technique is considered in which clustering is performed in such a way as to form a subclass with the number of samples comparable to the number of samples of a minority class, and contrast training is performed between clusters. However, even in this case, if noise is included in labels of the training data, there is a problem that accuracy of clustering becomes low and high-accuracy model learning is unable to be achieved.

In view of the above-described problem, an object of the present disclosure is to provide a label correction device, a label correction method, and a program capable of correcting an erroneous label included in training data.

In an example aspect of the present disclosure, there is provided a label correction device including:
a clustering means for classifying a set of pairs of an image and a class label indicating a class to which the image belongs, into subclasses by clustering a feature of the image;
a subclass identification means for identifying, among the subclasses, a noise-mixed subclass which includes a pair having an error in the class label, based on an index of a variation in the feature of each of the subclasses; and
a label correction means for selecting a subclass among the subclasses most similar to the pair belonging to the noise-mixed subclass from among all the subclasses, and replacing the class label of the pair belonging to the noise-mixed subclass with the class label indicating a class to which the selected subclass belongs.

In an example aspect of the present disclosure, there is provided a label correction method executed by a computer, including:
classifying a set of pairs of an image and a class label indicating a class to which the image belongs, into subclasses by clustering a feature of the image;
identifying, among the subclasses, a noise-mixed subclass which includes a pair having an error in the class label, based on an index of a variation in the feature of each of the subclasses; and
selecting a subclass among the subclasses most similar to the pair belonging to the noise-mixed subclass from among all the subclasses, and replacing the class label of the pair belonging to the noise-mixed subclass with the class label indicating a class to which the selected subclass belongs.

In an example aspect of the present disclosure, there is provided a program executed by a computer, the program causing the computer to:
classify a set of pairs of an image and a class label indicating a class to which the image belongs, into subclasses by clustering a feature of the image;
identify, among the subclasses, a noise-mixed subclass which includes a pair having an error in the class label, based on an index of a variation in the feature of each of the subclasses; and
select a subclass among the subclasses most similar to the pair belonging to the noise-mixed subclass from among all the subclasses, and replacing the class label of the pair belonging to the noise-mixed subclass with the class label indicating a class to which the selected subclass belongs.

An example advantage according to the present disclosure is to suitably correct an erroneous label included in training data.

### BRIEF DESCRIPTION OF THE DRAWINGS

FIG. 1 illustrates a schematic configuration of a training system.

FIG. 2 is a diagram illustrating an outline of the classification model.

FIG. 3 illustrates a hardware configuration of the training device.

FIG. 4 is a functional block diagram of the training device related to training of the classification model.

FIG. 5 is a diagram schematically illustrating distribution of subclasses in a feature space.

FIG. 6 is a diagram illustrating an outline of the inter-subclass training.

FIG. 7 is a diagram illustrating an outline of the inter-class training.

FIG. 8 is an example of a flowchart illustrating an outline of processing executed by the training device.

FIG. 9 illustrates a schematic configuration of the endoscopic examination system.

FIG. 10 shows a hardware configuration of the image processing device.

FIG. 11 illustrates an example of the display screen on the display device during the endoscopic examination.

FIG. 12 is a block diagram of the label correction device.

FIG. 13 is an example of a flowchart of the process executed by the label correction device.

Hereinafter, an example embodiment of a label correction device, a label correction method, and a program will be described with reference to the drawings.

### First Example Embodiment

### (1) System Configuration

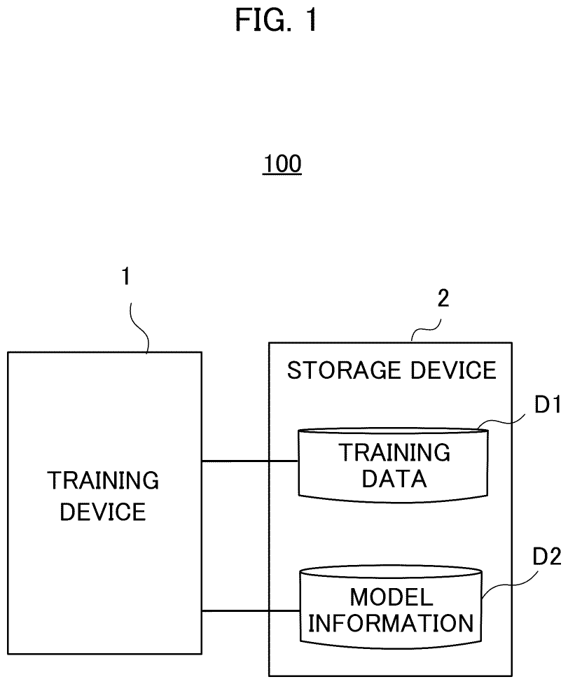

FIG. 1 illustrates a schematic configuration of a training system 100. As illustrated in FIG. 1, the training system 100 is a system that performs training of a model (also referred to as a “classification model M”) for classifying images, and the training system 100 uses, for training, training data D1 in which the number of samples for each class is biased and an error is mixed in a label. The training system 100 mainly includes a training device 1 and a storage device 2 that stores the training data D1 and model information D2.

For example, the classification model M is a classification model that performs, when an endoscopic image captured in an inspection using an endoscope for an organ of a person is input, classification regarding at least any of presence or absence of a lesion, a type of a lesion, or a degree of a lesion in an input endoscopic image. Examples of the endoscope to be an object in the present disclosure include a laryngendoscope, a bronchoscope, an upper digestive tube endoscope, a duodenum endoscope, a small bowel endoscope, a large bowel endoscope, a capsule endoscope, a thoracoscope, a laparoscope, a cystoscope, a cholangioscope, an arthroscope, a spinal endoscope, a blood vessel endoscope, and an epidural endoscope.

The classification model M as a training target is not limited to the classification model that performs classification regarding a lesion in the endoscopic image described above. For example, the classification model M may be a classification model that performs classification regarding a lesion in any given medical image (for example, an image obtained in an ultrasonic inspection, a PET inspection, a CT inspection, or an MRI inspection) other than that of the endoscope. In another example, the classification model M may be a classification model that performs, when an image (appearance inspection image) captured in an appearance inspection of an object other than a person is input, classification regarding at least any of presence or absence of abnormality, a type of abnormality, and a degree of abnormality in the input image.

The training device 1 performs machine learning (training) of the classification model M based on the training data D1 stored in the storage device 2, and updates the model information D2 stored in the storage device 2. As described later, the training device 1 corrects a label included in the training data D1.

The storage device 2 is a memory that stores information necessary for processing of the training device 1. The storage device 2 may be an external storage device such as a hard disk connected to or incorporated in the training device 1, a storage medium such as a flash memory, a server device that performs data communication with the training device 1, or the like. The storage device 2 may include a plurality of storage devices, and may hold each of the above-described storage units in a distributed manner. The storage device 2 includes the training data D1 and the model information D2.

The training data D1 is data used for machine learning of the classification model M by the training device 1. The training data D1 includes a plurality of records. Each record includes a training image that is an image to be input to the classification model M in machine learning, and a class label indicating a correct class to be output by the classification model M when the training image is input to the classification model M. That is, the training data D1 includes a set of pairs of the training image and the class label indicating the class of the training image. Hereinafter, each record of the training data D1 used for training of the classification model M is also referred to as a “sample”.

Here, in a case of classification regarding a lesion in a medical image, the class may be classified according to a type of the lesion (lesion type), or may be classified in consideration of a shape (a raised lesion, a flat lesion, and the like), malignancy grading, and the like of the lesion. In a case of classification regarding abnormality other than lesions, for example, the class is classified in consideration of presence or absence of abnormality and a degree of abnormality. The class label is generated in advance by annotation work, for example.

Here, the training data D1 is imbalanced data (unbalanced data) in which the number of samples for each class is biased, and noise (that is, a label indicating an incorrect class) is mixed in class labels indicating a correct class. For example, in a case where the classification model M is a model that classifies a lesion type in an input training image, for a class related to a lesion type that has a low prevalence, looks similar to another type of lesion, and is difficult to diagnose, the number of samples is small, and an error occurs in the class label. For example, a flat lesion (superficial lesion) is not distinctive in terms of a global color tone, shape, and the like even when compared with surroundings, and has a low prevalence and few cases, so that the number of samples is small. Hereinafter, a class label indicating a wrong class is also referred to as a “noise label”.

As described above, in classification of medical images related to lesions, the number of samples (that is, the number of cases) of malignant lesions is small, and it is difficult to distinguish the malignant lesions. Then, in a case where training data that is imbalanced data including such a noise label is used, it is difficult to obtain the classification model M that outputs a highly accurate classification result by machine learning. In machine learning of training data that is imbalanced data, there is a problem that overfitting easily occurs because samples of a minority class are frequently used. In consideration of the above, the training device 1 according to the present example embodiment corrects a noise label and executes contrast training capable of handling the imbalanced data as described later.

The model information D2 is information necessary for configuring the classification model M, and includes parameters of the classification model M that is updated by machine learning executed by the training device 1. The classification model M is, for example, a machine learning model (including a statistical model, the same applies hereinafter) having an optional architecture used for multitask learning, such as a neural network or a support vector machine. In a case where the classification model M is configured by the neural network, the model information D2 includes, for example, various parameters (including hyperparameters) such as a layer structure, a neuron structure of each layer, the number of filters and a filter size in each layer, and a weight of each element of each filter.

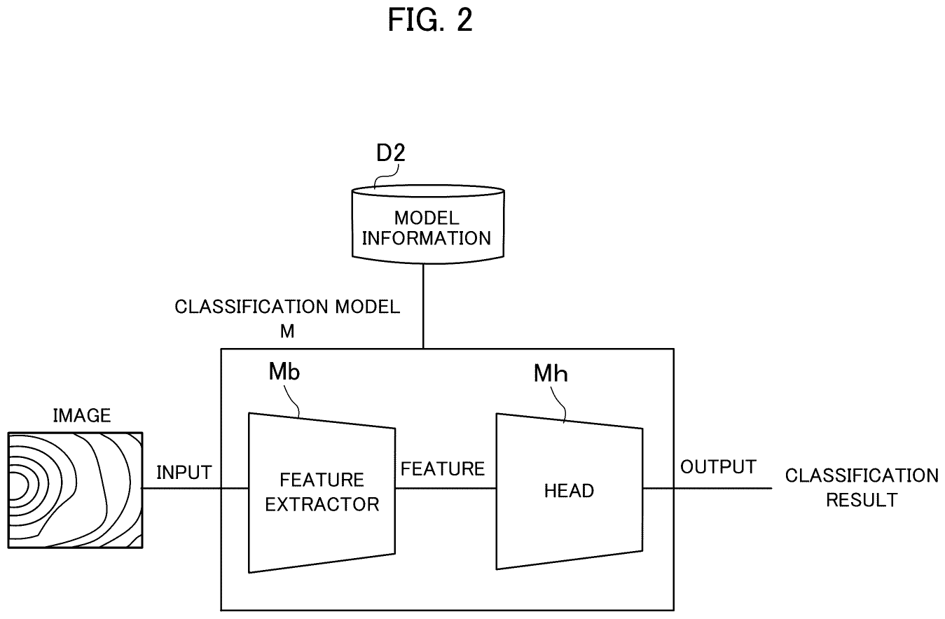

FIG. 2 is a diagram illustrating an outline of the classification model M. As illustrated in FIG. 2, the classification model M is a model (engine) that outputs, when an image is input to the classification model M, a classification result of a class to which the input image belongs. In other words, the classification model M is a model that has learned a relationship between an input image and a class to which the image belongs. The classification model M includes a feature extractor (backbone) Mb that extracts a feature, and a head Mh that outputs a classification result of the class based on the feature obtained by the feature extractor Mb. The “feature” is data (feature vector) in a vector format representing a feature. The feature may be data in a tensor format of a predetermined order, other than the vector format. The “classification result of the class” may be a score indicating certainty for each class to be a candidate, or may be a pair of a most certain class and a score indicating certainty of the class.

In the present example embodiment, it is assumed that the classification model M is subjected to machine learning in advance using a predetermined number of pairs of a training image and a class label, and parameters and the like obtained by the machine learning in advance are stored in the model information D2. This machine learning in advance may be executed by the training device 1 using the training data D1, or may be executed by a device other than the training device 1 using any given training data.

The configuration of the training system 100 illustrated in FIG. 1 is an example, and various changes may be made to the configuration. For example, the training device 1 and the storage device 2 may be implemented by the same device. In another example, the training device 1 may include a plurality of devices. In this case, the plurality of devices included in the training device 1 exchanges information necessary for executing pre-assigned processing between the devices by wired or wireless direct communication or by communication via a network.

### (2) Hardware Configuration

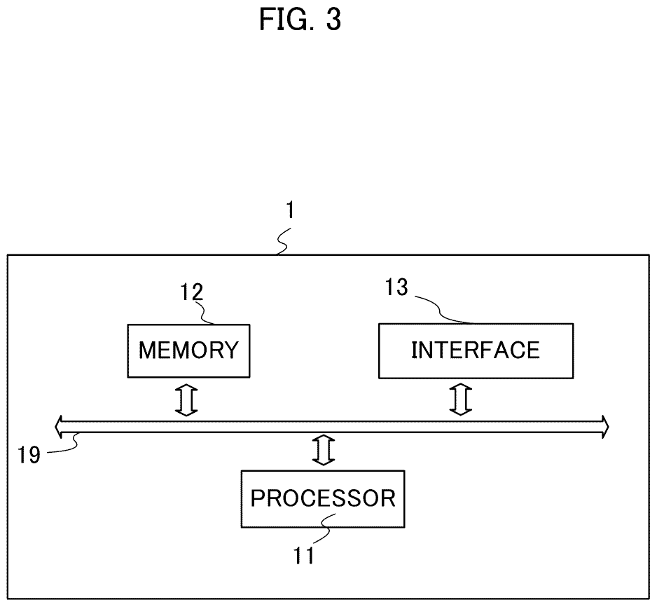

FIG. 3 illustrates a hardware configuration of the training device 1. The training device 1 includes a processor 11, a memory 12, and an interface 13 as hardware. The processor 11, the memory 12, and the interface 13 are connected via a data bus 19.

The processor 11 executes a predetermined processing by executing a program stored in the memory 12. The processor 11 is a processor such as a central processing unit (CPU), a graphics processing unit (GPU), or a tensor processing unit (TPU). The processor 11 may include a plurality of processors. The processor 11 is an example of a computer.

The memory 12 includes various volatile memories and nonvolatile memories, such as a random access memory (RAM), and a read only memory (ROM). The memory 12 stores a program executed by the training device 1. A part of the information stored in the memory 12 may be stored instead on the storage device 2 or any other external storage device capable of performing data communication with the training device 1 or may be stored on a storage medium detachable from the training device 1. The memory 12 may function as the storage device 2.

The interface 13 is an interface for electrically connecting the training device 1 and another device. This interface may be a wireless interface such as a network adapter for wirelessly transmitting and receiving data to and from the another device, or may be a hardware interface for connecting to the another device by a cable or the like.

### (3) Training of Classification Model

Next, training of the classification model M will be described in detail. Schematically, the training device 1 clusters samples sampled from the training data D1 in a feature space to form a subclass that is a group in which a class is classified in more detail. Thereafter, the training device 1 identifies a subclass mixed with a noise label, based on a variation in samples in the subclass. Then, the training device 1 corrects a label of each sample in the identified subclass according to a subclass having a highest similarity with the each sample, and performs contrast training between classes and between subclasses after correction. As a result, the training device 1 accurately corrects the noise label, and executes machine learning of the classification model M using imbalanced data without causing overfitting.

### (3-1) Functional Blocks

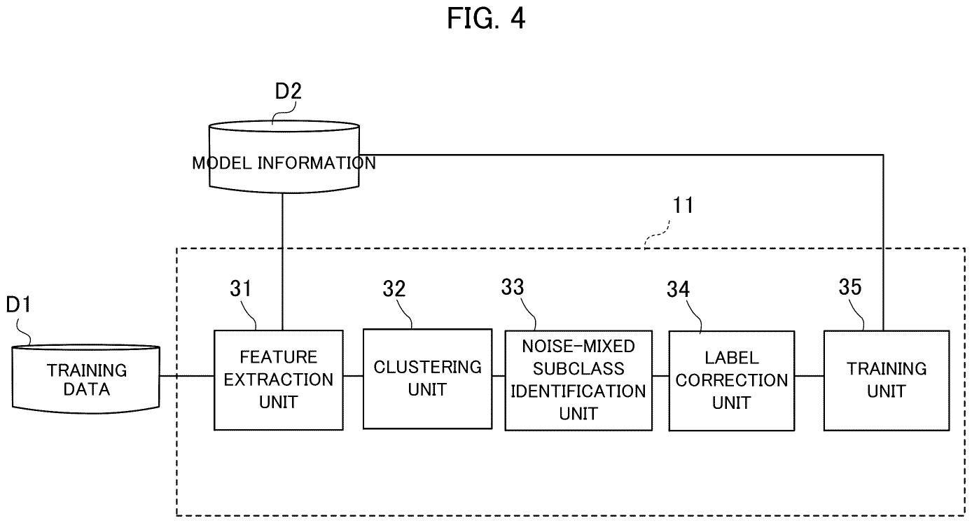

FIG. 4 is a functional block diagram of the training device 1 related to training of the classification model M. The processor 11 of the training device 1 functionally includes a feature extraction unit 31, a clustering unit 32, a noise-mixed subclass identification unit 33, a label correction unit 34, and a training unit 35. While blocks that exchange data with each other are connected by a solid line in FIG. 4, a combination of the blocks that exchange data with each other is not limited to that in FIG. 4. The same applies to diagrams of other functional blocks described later.

The feature extraction unit 31 samples “N” samples (that is, pairs of a training image and a class label) from the training data D1, and extracts features of N training images included in the sampled N samples. “N” is a positive integer, and is determined in advance in such a way as to be a number that enables generation of subclasses by clustering as described later. In this case, the feature extraction unit 31 configures the classification model M with reference to the model information D2, and acquires the feature output from the feature extractor Mb by inputting each training image to the feature extractor Mb of the classification model M. The feature extraction unit 31 supplies N pairs of a feature and a class label to the clustering unit 32. The N samples extracted from the training data D1 are an example of a “set of pairs”.

The clustering unit 32 classifies the N samples for each class based on the class label, and further classifies the samples classified for each class into subclasses by clustering of the feature. In this case, the clustering unit 32 clusters the samples for each class based on a similarity of the features. The “similarity” may be any given index representing a degree of the similarity, and may be, for example, a cosine similarity of features that are vectors, or a distance between features in a feature space representing the feature. A clustering algorithm may be non-hierarchical clustering such as a k-means method or a mixture of normal distributions, or may be hierarchical clustering such as a Ward's method, a centroid method, or a group average method. In this case, for example, the clustering unit 32 may perform clustering in such a way that a smallest class having a smallest number of samples has similar granularity (the number of samples or variations) as one subclass in other classes. In this case, for example, the smallest class becomes one subclass as a whole, and subclasses having similar granularity as the smallest class are formed in other classes. The clustering unit 32 supplies the features, class labels, and subclass labels indicating the subclass that are related to the N samples, to the noise-mixed subclass identification unit 33.

The noise-mixed subclass identification unit 33 identifies a subclass (also referred to as a “noise-mixed subclass”) including a sample including a noise label, based on the features, the class labels, and the subclass labels that are related to the N samples and supplied from the clustering unit 32. In this case, the noise-mixed subclass identification unit 33 calculates, for each subclass, a degree of variation (also referred to as “intra-subclass variance”) in the features of the samples belonging to each subclass. Then, the noise-mixed subclass identification unit 33 identifies the noise-mixed subclass based on the intra-subclass variance. Then, the noise-mixed subclass identification unit 33 supplies the features, the class labels, the subclass labels, and labels indicating whether to be the noise-mixed subclass that are related to the N samples, to the label correction unit 34.

The intra-subclass variance is not limited to a variance that is a statistical index value, and may be a value of any given index representing a degree of variation. For example, the intra-subclass variance may be a value of a determinant of a variance-covariance matrix of features, or may be a standard deviation of a specific component of the variance-covariance matrix. In other examples, the intra-subclass variance may be calculated as a variance of a cosine distance between samples. The same applies to a “variance” used hereinafter.

The label correction unit 34 obtains a similarity between each sample in the noise-mixed subclass and subclasses of all classes, and selects a subclass having a highest similarity (in a case where the similarity is a distance, a shortest distance, the same applies hereinafter) with each sample. Then, the label correction unit 34 replaces the class label in such a way that each sample belongs to the class of the selected subclass. As a result, the label correction unit 34 corrects the class label of the sample in the noise-mixed subclass having the highest similarity with the subclasses of other classes. The label correction unit 34 also replaces the subclass label of the sample whose class label has been changed, with a subclass label indicating the selected subclass. Then, the label correction unit 34 supplies the features related to the N samples, and the class labels and the subclass labels related to the N samples reflecting the correction, to the training unit 35.

The training unit 35 executes contrast training of the classification model M and updates parameters of the feature extractor Mb of the classification model M, based on the features of N samples and the class labels and subclass labels of the N samples reflecting the correction. Details of the contrast training will be described later. The training unit 35 stores the updated parameters of the feature extractor Mb in the model information D2.

Each component of the feature extraction unit 31, the clustering unit 32, the noise-mixed subclass identification unit 33, the label correction unit 34, and the training unit 35 can be realized, for example, by the processor 11 which executes a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

### (3-2) Identification of Noise-Mixed Subclass

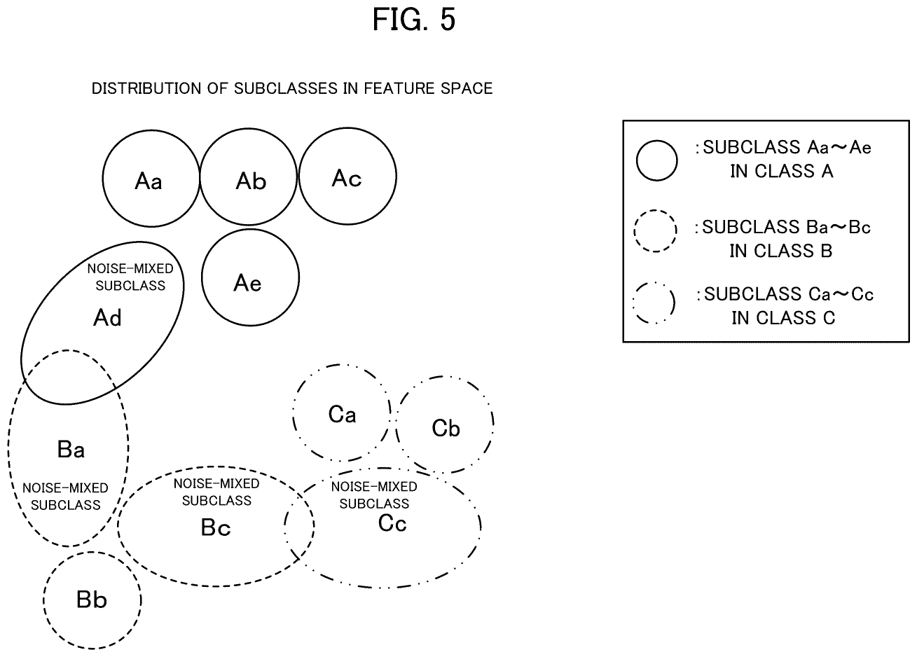

Next, identification of the noise-mixed subclass by the noise-mixed subclass identification unit 33 will be specifically described. FIG. 5 is a diagram schematically illustrating distribution of subclasses in a feature space of a feature extracted by the feature extraction unit 31. The feature space here is assumed to be a two-dimensional space for convenience of description. Here, there are classes A to C as candidate classes to be classified by the classification model M. The clustering unit 32 forms five subclasses Aa to Ae for the class A, forms three subclasses Ba to Bc for the class B, and forms three subclasses Ca to Cc for the class C. Here, distribution of the subclass Ad and distribution of the subclass Ba partially overlap, and distribution of the subclass Bc and distribution of the subclass Cc partially overlap.

In this case, the noise-mixed subclass identification unit 33 calculates an intra-subclass variance for each of all the subclasses Aa to Ae, Ba to Bc, and Ca to Cc. Then, the noise-mixed subclass identification unit 33 calculates an average of the intra-subclass variances for each class, and identifies a subclass having a larger intra-subclass variance than the calculated average as the noise-mixed subclass. That is, in this case, the noise-mixed subclass identification unit 33 sets the average of the intra-subclass variance for each class as a threshold of the intra-subclass variance for determining the noise-mixed subclass.

For example, in a case of the class A, the noise-mixed subclass identification unit 33 calculates an average of intra-subclass variances of the subclasses Aa to Ae. Then, since the intra-subclass variances of the subclasses Aa to Ac and Ae are equal to or less than the calculated average, while the intra-subclass variance of the subclass Ad is larger than the average, the noise-mixed subclass identification unit 33 identifies the subclass Ad as the noise-mixed subclass. Similarly, the noise-mixed subclass identification unit 33 identifies, as the noise-mixed subclass, each of the subclasses Ba and Bc having a larger intra-subclass variance than the average of the intra-subclass variances of the subclasses Ba to Bc. The noise-mixed subclass identification unit 33 identifies the subclass Cc having a larger intra-subclass variance than the average of the intra-subclass variances of the subclasses Ca to Cc, as the noise-mixed subclass.

The noise-mixed subclass identification unit 33 may execute processing of normalizing the intra-subclass variance in addition to the above-described processing. For example, for each class, the noise-mixed subclass identification unit 33 calculates an inter-subclass variance which is a variance between subclasses. For example, the noise-mixed subclass identification unit 33 determines an average of features of samples belonging to each subclass as a centroid (that is, a center point or a barycenter) in the feature space of each subclass. Instead of the centroid, the noise-mixed subclass identification unit 33 may use any given representative point representing the feature of the sample of the subclass in the feature space.

Then, the noise-mixed subclass identification unit 33 calculates a variance of the centroid of the subclass for each class, and uses the calculated variance as the inter-subclass variance. Then, the noise-mixed subclass identification unit 33 determines a value obtained by dividing each intra-subclass variance by the inter-subclass variance of the related class, as a normalized intra-subclass variance. In this case, the noise-mixed subclass identification unit 33 may set a predetermined value as a threshold of the intra-subclass variance after normalization for determining the noise-mixed subclass.

### (3-3) Label Correction

Next, label correction by the label correction unit 34 will be specifically described with reference to FIG. 5.

The label correction unit 34 calculates a similarity between each sample of the noise-mixed subclass identified by the noise-mixed subclass identification unit 33 and all the subclasses. In the example of FIG. 5, the label correction unit 34 calculates the above-described similarity for each sample of the subclasses Ad, Ba, Bc, and Cc identified as the noise-mixed subclasses. For example, in a case of the subclass Ad that is the noise-mixed subclass, each sample of the subclass Ad is set as a processing target sample. Then, the label correction unit 34 calculates a distance (for example, a cosine distance) between a feature of the processing target sample and each of the representative points of all the subclasses Aa to Ae, Ba to Bc, and Ca to Cc. The representative point of the subclass is, for example, a barycenter (centroid) of the feature in the feature space of the sample belonging to the subclass or another point representing the feature of the sample in the subclass. Instead of the above-described distance, the label correction unit 34 may calculate a value of any given index serving as an index of the similarity between the vectors.

Then, the label correction unit 34 selects a subclass having a shortest distance from the feature of the processing target sample, and determines that the processing target sample belongs to the class to which the selected subtask belongs. In this case, when the class label of the processing target sample is different from the class to which the selected subclass belongs, the label correction unit 34 corrects the class label of the processing target sample according to the determination result. The label correction unit 34 also replaces the subclass label of the processing target sample whose class label has been changed, with a subclass label indicating a subclass having a shortest distance to the sample.

For example, when the label correction unit 34 determines that the sample of the subclass Ad has a shortest distance to the subclass Ba in all the subclasses, the label correction unit 34 replaces the class label “class A” of the sample with “class B”. The label correction unit 34 replaces the subclass label “Ad” of the sample with “Ba”. Then, the label correction unit 34 sets the class labels and the subclass labels of the samples of the subclasses Ba, Ba, Bc, and Cc identified as the noise-mixed subclasses in such a way as to match a subclass having a shortest distance.

As described above, the label correction unit 34 can improve clustering accuracy by performing label correction, effectively perform contrast training of the classification model M to be described later, and can improve the classification accuracy of the classification model M.

### (3-4) Contrastive Training

The training unit 35 executes contrast training of the feature extractor Mb of the classification model M, based on the features of N samples and the class labels and the subclass labels of N samples reflecting the correction. In this case, the training unit 35 executes inter-subclass training for training (learning) the feature extractor Mb in such a way as to move (repel) different subclasses away from each other and inter-class training for training the feature extractor Mb in such a way as to move (repel) different classes away from each other and bring (attract) subclasses of the same class close to each other.

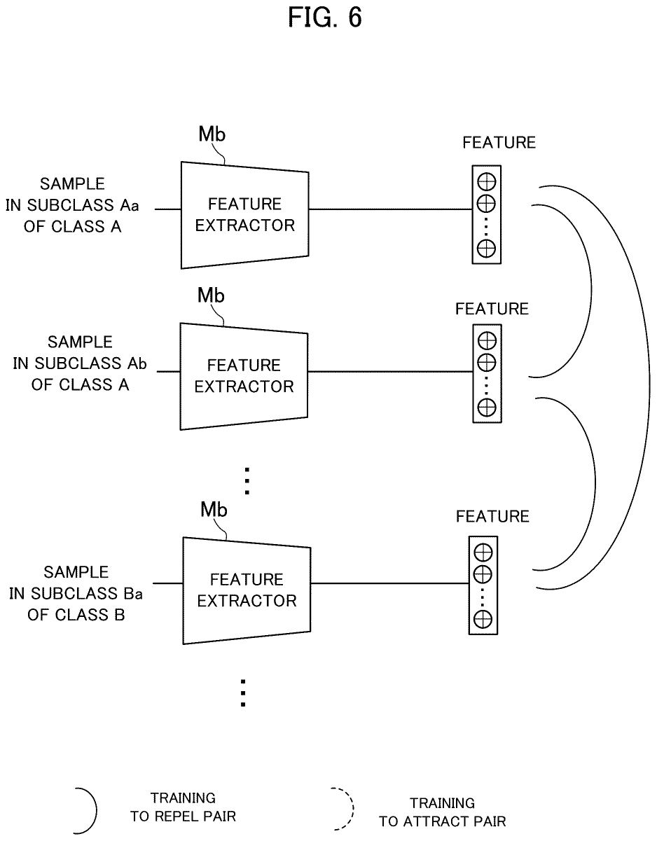

FIG. 6 is a diagram illustrating an outline of the inter-subclass training. Here, an outline of the inter-subclass training regarding samples belonging to the classes A and B is illustrated.

In the inter-subclass training, the training unit 35 updates the parameters of the feature extractor Mb in such a way that the features output from the feature extractor Mb are moved away from each other, by inputting training images of samples belonging to different subclasses to the feature extractor Mb regardless of whether the classes are the same. The inter-subclass training is relevant to first contrast training of training the feature extractor Mb in such a way that the features of any given two pairs having the same subclass are brought close to each other and the features of any given two pairs having different subclasses are moved away from each other.

In the example illustrated in FIG. 6, the training unit 35 updates the parameters of the feature extractor Mb in such a way that the feature of the sample of the subclass Aa of the class A and the feature of the sample of the subclass Ab of the same class A are moved away from each other. The training unit 35 updates the parameters of the feature extractor Mb in such a way that the feature of the sample of the subclass Aa of the class A and the feature of the sample of the subclass Ba of the different class B are moved away from each other. Similarly, the training unit 35 updates the parameters of the feature extractor Mb in such a way that the feature of the sample of the subclass Ab of the class A and the feature of the sample of the subclass Ba of the different class B are moved away from each other. Whereas, the training unit 35 updates the parameters of the feature extractor Mb in such a way that the features of any given two samples in the same subclass are brought close to each other.

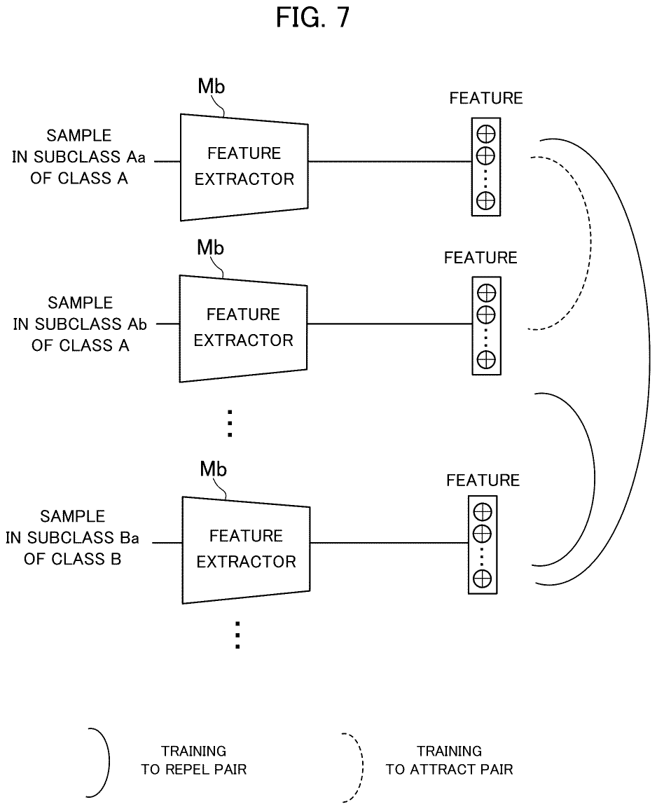

FIG. 7 is a diagram illustrating an outline of the inter-class training. In the inter-class training, the training unit 35 updates parameters of the feature extractor Mb in such a way that the features output from the feature extractor Mb are moved away from each other, by inputting training images of samples belonging to different classes to the feature extractor Mb. The inter-class training is relevant to second contrast training of training the feature extractor Mb in such a way that the features of any given two pairs having the same class are brought close to each other and the features of any given two pairs having different classes are moved away from each other.

In the example illustrated in FIG. 7, the training unit 35 updates the parameters of the feature extractor Mb in such a way that the feature of the sample of the subclass Aa of the class A and the feature of the sample of the subclass Ab of the same class A are brought close to each other. Whereas, the training unit 35 updates the parameters of the feature extractor Mb in such a way that the feature of the sample of the subclass Aa of the class A and the feature of the sample of the subclass Ba of the different class B are moved away from each other. Similarly, the training unit 35 updates the parameters of the feature extractor Mb in such a way that the feature of the sample of the subclass Ab of the class A and the feature of the sample of the subclass Ba of the different class B are moved away from each other.

The training unit 35 may repeatedly execute the contrast training using the N samples, and then perform the machine learning of the entire classification model M including the head Mh using the training data D1. In this case, when a training image is input to the classification model M, the training unit 35 updates the parameters of the classification model M in such a way as to minimize an error (loss) between the classification result of the class output by the classification model M and the class label associated with the input training image. An algorithm for determining the parameters described above in such a way as to minimize the error may be an optional training algorithm used in machine learning such as gradient descent or back propagation. In the training of the entire classification model M, the training unit 35 may use a class label reflecting label correction by the label correction unit 34. Instead of the above-described contrast training, the training unit 35 may execute machine learning of the entire classification model M including the head Mh using the training data D1. Even in this case, the training unit 35 can train the classification model M based on the training data D1 whose class label is corrected.

### (4) Processing Flow

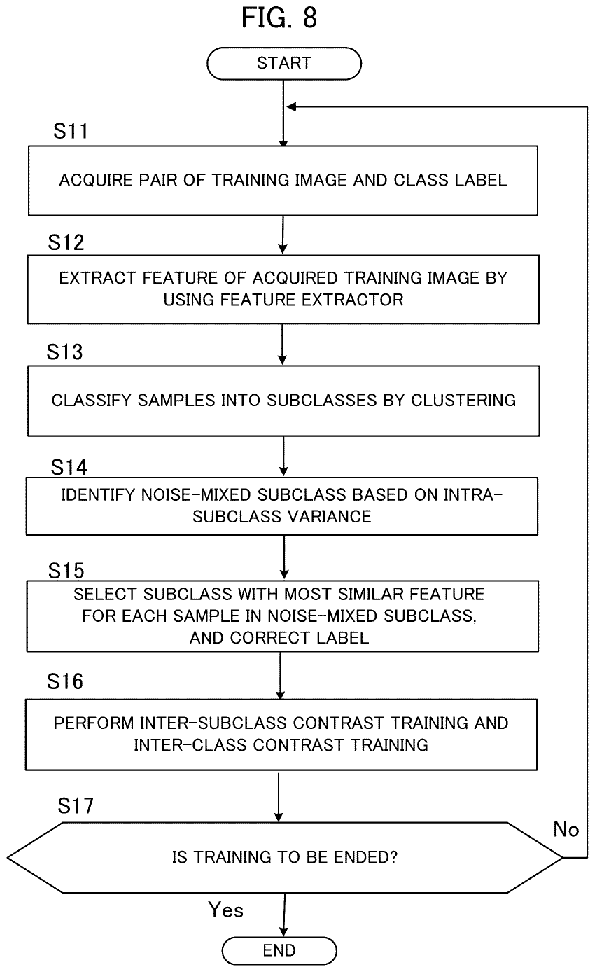

FIG. 8 is an example of a flowchart illustrating an outline of processing executed by the training device 1.

First, from the training data D1 stored in the storage device 2, the training device 1 samples N pairs of a training image and a class label, which are N samples used for training of the classification model M (step S11). In this case, for example, the training device 1 samples the N pairs from the training data D1 by random extraction.

Next, the training device 1 extracts a feature of the training image acquired in step S11, by using the feature extractor Mb (step S12). In this case, the training device 1 acquires the feature output from the feature extractor Mb by inputting the training image to the feature extractor Mb configured with reference to the model information D2 of the trained classification model M. As a result, the training device 1 acquires N features related to the N training images.

Next, the training device 1 executes clustering based on a similarity of the feature (for example, a distance in the feature space) for the N samples, and classifies the samples into subclasses more detailed than the classes (step S13). As a result, the training device 1 generates a subclass label of each sample. The subclass label is used for contrast training.

Next, the training device 1 calculates an intra-subclass variance of each subclass, and identifies a noise-mixed subclass from the subclasses identified in step S13 based on the subclass variance (step S14). Then, the training device 1 calculates a similarity with each subclass for each sample in the identified noise-mixed subclass, and selects a subclass having a maximum similarity. Then, the training device 1 corrects the class label and the subclass label according to the selected subclass (step S15). In this case, the training device 1 sets the class label and the subclass label of each sample in such a way as to belong to the selected subclass.

Next, the training device 1 refers to the corrected class label and subclass label, and executes the contrast training between subclasses and the contrast training between classes (step S16). As a result, the training device 1 updates the parameters of the feature extractor Mb, and reflects the updated parameters in the model information D2.

Then, the training device 1 determines whether training is ended (step S17). For example, the training device 1 determines to end the training in a case where the training of the classification model M has been performed using all the samples of the training data D1, in a case where steps S11 to S16 have been repeated a predetermined number of times, or in a case where other predetermined training end condition is satisfied. Then, in a case where it is determined not to end the training (step S17; No), the training device 1 returns the processing to step S11. In this case, in step S11, the training device 1 may extract a sample not used for training of the classification model M from the training data D1.

Whereas, in a case where it is determined to end the training (step S17; Yes), the training device 1 ends the processing of the flowchart. In this case, the training device 1 may execute the machine learning of the entire classification model M including the head Mh using the pair of the training image and the class label included in the training data D1. The class label of the training data D1 used in this case reflects the correction in step S15.

### (5) Application Example

A description will be given of an application example in which the classification model M after machine learning process by the training device 1. As a representative example, the classification model M is assumed to be a classification model configured to take an endoscopic image as input and output a classification result on a lesion in the endoscopic image.

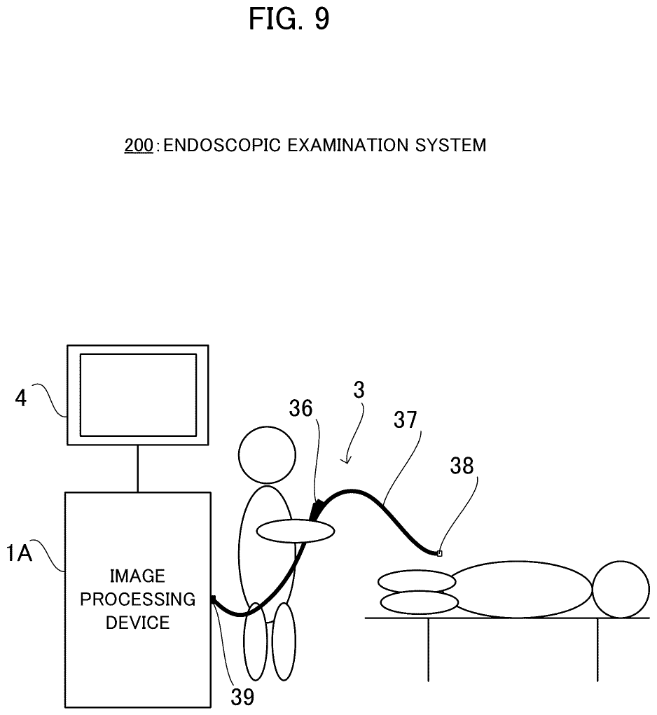

FIG. 9 illustrates a schematic configuration of the endoscopic examination system 200. The endoscopic examination system 200 performs classification on the lesion in the endoscopic image captured by an endoscope to present the classification result. The endoscopic examination system 200 mainly includes an image processing device 1A, an endoscope 3 connected to the image processing device 1A and subjected to operation by an examiner such as a doctor, and a display device 4.

The image processing device 1A acquires an image (also referred to as “endoscopic image Ia”) captured by the endoscope 3 in time series and displays a screen image based on the endoscopic image Ia on the display device 4. The endoscopic image Ia is an image captured at a predetermined frame rate in at least one of the insertion process of the endoscope 3 to the subject and/or the ejection process of the endoscope 3 from the subject. The image processing device 1A according to this application example classifies each endoscopic image Ia in time series using the classification model M concerning lesion to thereby present information on the classification result. For example, upon detecting an endoscopic image Ia which include a lesion, the image processing device 1A notifies the examiner of the presence of the lesion. In some embodiments, the image processing device 1A functions as the training device 1 according to the first example embodiment and performs regarding machine learning process on the classification model M before the endoscopic examination.

The endoscope 3 mainly includes an operation unit 36 for examiner to perform a predetermined input, a shaft 37 which has flexibility and which is inserted into the organ to be photographed of the subject, a tip unit 38 having a built-in photographing unit such as an ultra-small image pickup device, and a connecting unit 39 for connecting with the image processing device 1A.

The configuration of the endoscopic examination system 200 shown in FIG. 9 is an example, and various change may be applied thereto. For example, the image processing device 1A may be configured integrally with the display device 4. In another example, the image processing device 1A may be configured by a plurality of devices.

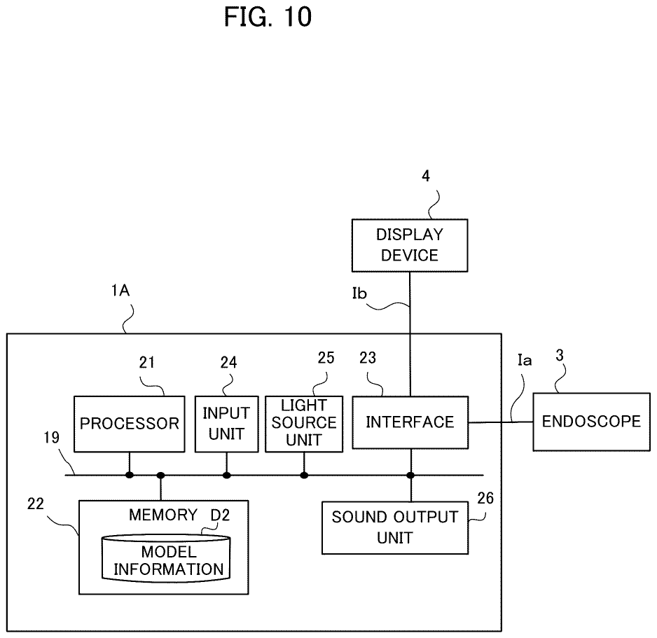

FIG. 10 shows a hardware configuration of the image processing device 1A. The image processing device 1A mainly includes a processor 21, a memory 22, an interface 13, an input unit 14, a light source unit 15, and an audio output unit 16. Each of these elements is connected to one another via a data bus 19.

The processor 21 executes a predetermined process by executing a program or the like stored in the memory 22. The processor 21 is one or more processors such as a CPU, a GPU, and a TPU. The processor 21 may be configured by a plurality of processors. The processor 21 is an example of a computer.

The memory 22 is configured by a variety of volatile memories which is used as working memories, and nonvolatile memories which stores information necessary for the process to be executed by the image processing device 1A, such as a RAM and a ROM. The memory 22 may include an external storage device such as a hard disk connected to or built in to the image processing device 1, or may include a storage medium such as a removable flash memory. The memory 22 stores a program for the image processing device 1A to execute each process in the present example embodiment.

The memory 22 stores model information D2 on the classification model M which is trained in advance through machine learning according to the first example embodiment. The model information D2 includes parameters of the classification model M obtained through the machine learning. The memory 22 may also include any other information necessary for the image processing device 1X to perform each process in the application example.

The interface 23 performs an interface operation between the image processing device 1A and an external device. For example, the interface 23 supplies the display information “Ib” generated by the processor 21 to the display device 4. Further, the interface 23 supplies the light generated by the light source unit 25 to the endoscope 3. The interface 23 also provides an electrical signal to the processor 21 indicative of the endoscopic image Ia supplied from the endoscope 3. The interface 23 may be a communication interface, such as a network adapter, for wired or wireless communication with the external device, or a hardware interface compliant with a USB, a SATA, or the like.

The input unit 24 generates an input signal based on the operation by the examiner. Examples of the input unit 24 include a button, a touch panel, a remote controller, and a voice input device. The light source unit 25 generates light for supplying to the tip unit 38 of the endoscope 3. The light source unit 25 may also incorporate a pump or the like for delivering water and air to be supplied to the endoscope 3. The sound output unit 26 outputs a sound under the control of the processor 21.

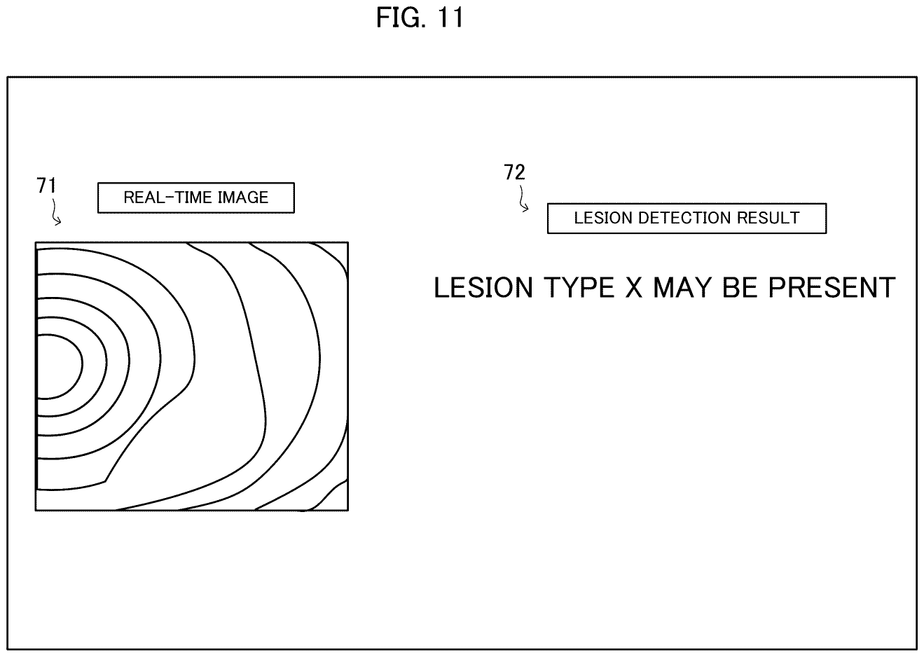

FIG. 11 illustrates an example of the display screen on the display device 4 during the endoscopic examination. The image processing device 1A output, to the display device 4, the display information Ib generated based on the endoscopic image Ia and the classification model M configured with reference to the model information D2. The image processing device 1A transmits the display information Ib to the display device 4 to thereby cause the display device 4 to display the display screen. In the display screen shown in FIG. 11, the image processing device 1A provides on the display screen a real-time image display field 71 and a lesion detection result display field 72.

The image processing device 1A displays a moving image of the latest endoscopic image Ia on the real-time image display field 71. On the lesion detection result display field 72, the image processing device 1A a classification result output by the classification model M when the classification model M takes the endoscopic image Ia displayed on the real-time image display field 71 as input. As of the time of the display screen shown in FIG. 11, the classification result which indicates the presence of the lesion type X is obtained by the classification model M. Thus, the image processing device 1A displays on the lesion detection result display field 72 a text message to the effect that the lesion type X may be present. In some embodiments, the image processing device 1A may output by the sound output unit 26 a sound or a voice announcing that a lesion may be present.

The endoscopic examination system 200 with the above-mentioned configuration accurately classifies endoscopic images Ia obtained by photographing the organ of the subject to thereby inform the examiner of the classification result.

### Second Example Embodiment

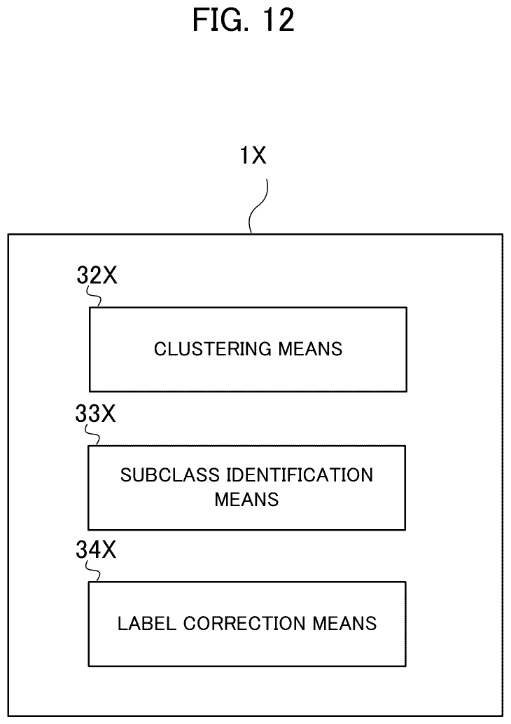

FIG. 12 is a block diagram of the label correction device 1X. The label correction device 1X mainly includes a clustering means 32X, a subclass identification means 33X, and a label correction means 34X. Examples of the label correction device 1X include the training device 1 according to the first example embodiment. The label correction device 1X may be configured by plural devices.

The clustering means 32X is configured to classify a set of pairs of an image and a class label indicating a class to which the image belongs, into subclasses by clustering a feature of the image. Examples of the clustering means 32X include the clustering means 32 according to the first example embodiment.

The subclass identification means 33X is configured to identify, among the subclasses, a noise-mixed subclass which includes a pair having an error in the class label, based on an index of a variation in the feature of each of the subclasses. Examples of the subclass identification means 33X include the noise-mixed subclass identification unit 33 according to the first example embodiment.

The label correction means 34X is configured to select a subclass among the subclasses most similar to the pair belonging to the noise-mixed subclass from among all the subclasses, and replace the class label of the pair belonging to the noise-mixed subclass with the class label indicating a class to which the selected subclass belongs. It is noted herein that if the class label before and after replacement is identical, the label will not be changed. Examples of the label correction means 34X include the label correction unit 34 according to the first example embodiment.

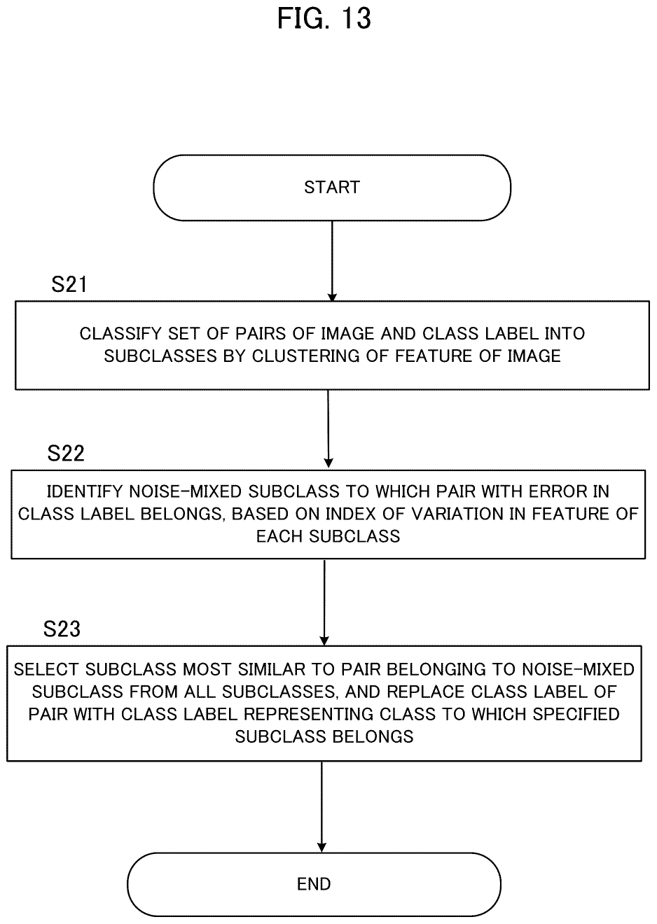

FIG. 13 is an example of a flowchart of the process executed by the label correction device 1X. The clustering means 32X classifies a set of pairs of an image and a class label indicating a class to which the image belongs, into subclasses by clustering a feature of the image (step S21). The subclass identification means 33X identifies, among the subclasses, a noise-mixed subclass which includes a pair having an error in the class label, based on an index of a variation in the feature of each of the subclasses (step S22). The label correction means 34X selects a subclass among the subclasses most similar to the pair belonging to the noise-mixed subclass from among all the subclasses, and replaces the class label of the pair belonging to the noise-mixed subclass with the class label indicating a class to which the selected subclass belongs (step S23).

The label correction device 1X according to the second example embodiment can accurately correct the class label even if noises in class labels are mixed with a set of pairs of an image and a class label. After correcting the class labels, the resulting set of pairs can be used to train a machine learning model that accurately classifies images.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above-described example embodiments may also be described as following Supplementary Notes, but are not limited to the following. All or a part of the configuration described in Supplementary Notes 2 to 8 which depend on Supplementary Note 1 can also be applied to Supplementary Notes 9 and 10 in the same dependent relationship. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### Supplementary Note 1

A label correction device comprising:
a clustering means for classifying a set of pairs of an image and a class label indicating a class to which the image belongs, into subclasses by clustering a feature of the image;
a subclass identification means for identifying, among the subclasses, a noise-mixed subclass which includes a pair having an error in the class label, based on an index of a variation in the feature of each of the subclasses; and
a label correction means for selecting a subclass among the subclasses most similar to the pair belonging to the noise-mixed subclass from among all the subclasses, and replacing the class label of the pair belonging to the noise-mixed subclass with the class label indicating a class to which the selected subclass belongs.

### Supplementary Note 2

The label correction device according to Supplementary Note 1, wherein the label correction means determines a representative point for each of the subclasses in a feature space of the feature, selects a subclass among the subclasses to be the representative point most similar to the feature related to the pair belonging to the noise-mixed subclass, and replaces the class label of the pair belonging to the noise-mixed subclass with the class label indicating a class to which the selected subclass belongs.

### Supplementary Note 3

The label correction device according to Supplementary Note 1, wherein the subclass identification means normalizes an index of a variation in the feature of each of the subclasses based on an index of a variation between subclasses in the class to which the each of the subclasses belongs, and identifies the noise-mixed subclass based on the normalized index of the variation in the feature of each of the subclasses.

### Supplementary Note 4

The label correction device according to Supplementary Note 1, wherein
the subclass identification means identifies the noise-mixed subclass based on comparison between an index of a variation in the feature and a predetermined threshold, and
the subclass identification means sets the threshold based on an average of the index of the variation in the feature of each of the classes.

### Supplementary Note 5

The label correction device according to Supplementary Note 1, further comprising a training means for executing contrast training of a feature extractor that extracts the feature from the image, based on the replaced class label.

### Supplementary Note 6

The label correction device according to Supplementary Note 5, wherein
the training means regards the pair belonging to the noise-mixed subclass as belonging to the selected subclass, and
the training means executes:
first contrast training of training the feature extractor to
   attract features of any given two of the pairs belonging to a same subclass and
   repel features of any given two of the pairs belonging to different subclasses; and second contrast training of training the feature extractor to
   attract features of any given two of the pairs belonging to a same class and
   repel features of any given two of the pairs belonging to different classes.

### Supplementary Note 7

The label correction device according to Supplementary Note 1, further comprising a training means for performing, based on the set of the pairs including the replaced class label, machine learning of a classification model configured to take an image as input and output a classification result of the image.

### Supplementary Note 8

The label correction device according to Supplementary Note 1, wherein
the image is a medical image, and
the class is a class classified based on at least any of presence or absence of a lesion, a type of a lesion, or a degree of a lesion in the medical image.

### Supplementary Note 9

A label correction method executed by a computer, comprising:
classifying a set of pairs of an image and a class label indicating a class to which the image belongs, into subclasses by clustering a feature of the image;
identifying, among the subclasses, a noise-mixed subclass which includes a pair having an error in the class label, based on an index of a variation in the feature of each of the subclasses; and
selecting a subclass among the subclasses most similar to the pair belonging to the noise-mixed subclass from among all the subclasses, and replacing the class label of the pair belonging to the noise-mixed subclass with the class label indicating a class to which the selected subclass belongs.

### Supplementary Note 10

A non-transitory computer readable storage medium storing a program executed by a computer, the program causing the computer to:
classify a set of pairs of an image and a class label indicating a class to which the image belongs, into subclasses by clustering a feature of the image;
identify, among the subclasses, a noise-mixed subclass which includes a pair having an error in the class label, based on an index of a variation in the feature of each of the subclasses; and
select a subclass among the subclasses most similar to the pair belonging to the noise-mixed subclass from among all the subclasses, and replacing the class label of the pair belonging to the noise-mixed subclass with the class label indicating a class to which the selected subclass belongs.

### Supplementary Note 11

A non-transitory computer readable storage medium storing the program according to Supplementary Note 10.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Training device
1X Label correction device
2 Storage device
11, 21 Processor
12, 22 Memory
13, 23 Interface
100 Training system
200 Endoscopic examination system
D1 Training data
D2 Model information

What is claimed is:

1. A label correction device comprising:
at least one memory configured to store instructions, and
at least one processor configured to execute the instructions to:
classify a set of pairs of an image and a class label indicating a class to which the image belongs, into subclasses by clustering a feature of the image;
identify, among the subclasses, a noise-mixed subclass which includes a pair having an error in the class label, based on an index of a variation in the feature of each of the subclasses; and
select a subclass among the subclasses most similar to the pair belonging to the noise-mixed subclass from among all the subclasses, and replacing the class label of the pair belonging to the noise-mixed subclass with the class label indicating a class to which the selected subclass belongs.

2. The label correction device according to claim 1, wherein the at least one processor is configured to execute the instructions to
determine a representative point for each of the subclasses in a feature space of the feature,
select a subclass among the subclasses to be the representative point most similar to the feature related to the pair belonging to the noise-mixed subclass, and
replace the class label of the pair belonging to the noise-mixed subclass with the class label indicating a class to which the selected subclass belongs.

3. The label correction device according to claim 1, wherein the at least one processor is configured to execute the instructions to
normalize an index of a variation in the feature of each of the subclasses based on an index of a variation between subclasses in the class to which the each of the subclasses belongs, and
identify the noise-mixed subclass based on the normalized index of the variation in the feature of each of the subclasses.

4. The label correction device according to claim 1, wherein the at least one processor is configured to execute the instructions to
identify the noise-mixed subclass based on comparison between an index of a variation in the feature and a predetermined threshold, and
set the threshold based on an average of the index of the variation in the feature of each of the classes.

5. The label correction device according to claim 1, wherein the at least one processor is configured to further execute the instructions to execute contrast training of a feature extractor that extracts the feature from the image, based on the replaced class label.

6. The label correction device according to claim 5, wherein the at least one processor is configured to execute the instructions to
regard the pair belonging to the noise-mixed subclass as belonging to the selected subclass, and
execute:
first contrast training of training the feature extractor to
attract features of any given two of the pairs belonging to a same subclass and
repel features of any given two of the pairs belonging to different subclasses; and second contrast training of training the feature extractor to
attract features of any given two of the pairs belonging to a same class and
repel features of any given two of the pairs belonging to different classes.

7. The label correction device according to claim 1, wherein the at least one processor is configured to further execute the instructions to
perform, based on the set of the pairs including the replaced class label, machine learning of a classification model configured to take an image as input and output a classification result of the image.

8. The label correction device according to claim 1, wherein
the image is a medical image, and
the class is a class classified based on at least any of presence or absence of a lesion, a type of a lesion, or a degree of a lesion in the medical image.

9. A label correction method executed by a computer, comprising:
classifying a set of pairs of an image and a class label indicating a class to which the image belongs, into subclasses by clustering a feature of the image;
identifying, among the subclasses, a noise-mixed subclass which includes a pair having an error in the class label, based on an index of a variation in the feature of each of the subclasses; and
selecting a subclass among the subclasses most similar to the pair belonging to the noise-mixed subclass from among all the subclasses, and replacing the class label of the pair belonging to the noise-mixed subclass with the class label indicating a class to which the selected subclass belongs.

10. A non-transitory computer readable storage medium storing a program executed by a computer, the program causing the computer to:
classify a set of pairs of an image and a class label indicating a class to which the image belongs, into subclasses by clustering a feature of the image;
identify, among the subclasses, a noise-mixed subclass which includes a pair having an error in the class label, based on an index of a variation in the feature of each of the subclasses; and
select a subclass among the subclasses most similar to the pair belonging to the noise-mixed subclass from among all the subclasses, and replacing the class label of the pair belonging to the noise-mixed subclass with the class label indicating a class to which the selected subclass belongs.
